(19) United States
(12) Patent Application Publication
(10) Pub. No.: US 2011/0149425 A1
(43) Pub. Date: Jun. 23, 2011

(54) SYSTEM FOR MONITORING LSI SUPPLYING CURRENT TO LOAD

(75) Inventors: Toshifumi HATAGAMI, Machida-shi (JP); Kenji ITOU, Kawasaki-shi (JP)

(73) Assignee: KABUSHIKI KAISHA TOSHIBA, Tokyo (JP)

(21) Appl. No.: 12/856,410

(22) Filed: Aug. 13, 2010

(30) Foreign Application Priority Data
Dec. 18, 2009 (JP) 2009-288317

(51) Int. Cl. G11B 5/09; H02J 1/10

(52) U.S. Cl. 360/46; 307/43; G9B/5.033

(57) ABSTRACT

According to one embodiment, A system includes a first LSI, a second LSI, a controller and a current monitoring and determination module. The first LSI operates on a first power supply voltage generated by a first voltage regulator included in the second LSI. The module operates on a device power supply voltage supplied from the device power supply. The module monitors current flowing between the first LSI and the first voltage regulator, determines an abnormality in the first LSI on the basis of the current monitoring result and transmits an abnormality signal to the controller on the basis of the abnormality determination result. The controller operates on a second power supply voltage generated by a second voltage regulator included in the second LSI and reports an abnormality in the first LSI to a host system in accordance with the reception of the abnormality signal.

### CROSS-REFERENCE TO RELATED APPLICATIONS

This application is based upon and claims the benefit of priority from Japanese Patent Application No. 2009-288317, filed Dec. 18, 2009; the entire contents of which are incorporated herein by reference.

### FIELD

Embodiments described herein relate generally to a system for monitoring an LSI that supplies current to a load.

### BACKGROUND

A magnetic disk drive includes a read/write amplifier IC (a so-called head IC) for supplying current to a head to read and write data with the head. Jpn. Pat. Appln. KOKAI Publication No. 64-013204 (hereinafter, referred to as document 1) has disclosed that a read/write amplifier IC includes a malfunction detector. The malfunction detector detects an abnormality in write current supplied to the head. Jpn. Pat. Appln. KOKAI Publication No. 2-267706 (hereinafter, referred to as document 2) has also disclosed a malfunction detector. The malfunction detector in document 2 detects an abnormality in each of all the power supply voltages applied to the read/write amplifier IC and an abnormality in write current supplied from the read/write amplifier IC to the magnetic head. Use of the malfunction detector in the read/write amplifier IC makes it possible to detect write failure quickly.

Jpn. Pat. Appln. KOKAI Publication No. 2006-275700 (hereinafter, referred to as document 3) has disclosed a first system which detects an abnormal operation of an electronic circuit, such as an LSI. In the first system, a monitoring device is provided in a place different from that of a monitored device configured as, for example, a state machine. The monitoring device detects the consumption current and time period for each state of the monitored device by use of a current detector. If the detection result has deviated from the range of the expected value indicated by information preset in, for example, an external nonvolatile memory provided on the monitoring device, the monitoring device determines that the monitored device is abnormal. In this case, the monitoring device reports the abnormality of the monitored device to the monitored device in the form of a reset signal. The monitored device itself informs the monitoring device of the state number indicating the state of the monitored device.

Jpn. Pat. Appln. KOKAI Publication No. 2-219109 (hereinafter, referred to as document 4) has disclosed a second system which detects an abnormality in an electronic control circuit including a CPU and an IC constituting a peripheral circuit of the CPU. In the second system, the electronic control circuit includes a consumption current detector. The consumption current detector detects, for example, consumption current in the electronic control circuit. The CPU in the electronic control circuit functions as an estimator and estimates consumption current of the electronic control circuit. The CPU functions as a malfunction detector and detects a malfunction of the electronic control circuit on the basis of the detected consumption current and the estimated consumption current. In the second system, the electronic control device acts as the monitored device and consumptions current of the entire electronic control circuit is detected. The CPU in which a part of the consumption current flows, that is, the CPU included in the monitored device, is used as the monitoring device.

In the conventional art described in documents 1 and 2, an abnormality in write current supplied from the read/write amplifier IC to the head is detected by a malfunction detector provided in the read/write amplifier IC. In commercially available magnetic disk drives, such a malfunction detector is generally included in the read/write amplifier IC.

When the read/write amplifier IC itself is out of order because a crack has occurred in the read/write amplifier IC, there is a good chance that the malfunction detector provided in the IC chip constituting the read/write amplifier IC may be at fault. In this case, even if a write operation has been performed, no write current flows in the write head and the data pattern in the written place on the medium might be the same as before the write operation. Therefore, just reading data from the written place might result in successful completion with no error in an error check process using, for example, an error-correcting code (ECC). Therefore, to detect write failure, it is necessary to read data from the written place after the write operation and compare the read data with the write data.

In the first system, the monitored device itself informs the monitoring device of its state. The monitoring device compares current detected by the current detector with the range of the expected value corresponding to the state reported by the monitored device, thereby determining whether the monitored device is abnormal. Accordingly, in the first system, it is necessary to inform the monitoring device of the state of the monitored device correctly.

In the second system, a monitoring device (CPU) and a consumption current detector used to determine whether the monitored device is abnormal are both provided in the monitored device. Therefore, in the second system, if the monitored device has failed, the monitoring device and consumption current detector have difficulty in operating properly.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram showing an exemplary configuration of a magnetic disk drive according to an embodiment;

FIG. 2 shows an exemplary configuration of the main mechanical part of the magnetic disk drive of the embodiment;

FIG. 3 is a block diagram showing an exemplary configuration of a read/write amplifier IC of the embodiment;

FIG. 4 is a block diagram showing an exemplary configuration of a negative voltage regulator and a first current monitoring and determination module of the embodiment;

FIG. 5 is an exemplary timing chart when the first current monitoring and determination module detects that the read/write amplifier IC is abnormal in the embodiment;

FIG. 6 is an exemplary timing chart when the first current monitoring and determination module detects that the read/write amplifier IC is normal in the embodiment; and

FIG. 7 is a block diagram showing an exemplary configuration of the monitoring system in the magnetic disk drive of the embodiment in connection with the components of the magnetic disk drive.

### DETAILED DESCRIPTION

Various embodiments will be described hereinafter with reference to the accompanying drawings. In general, according to one embodiment, a system comprises a first LSI, a second LSI, a controller and a current monitoring and determination module. The first LSI is configured to drive a load by supplying current to the load and to operate on a first power supply voltage. The second LSI comprises a first voltage regulator and a second voltage regulator. The first voltage regulator is configured to generate the first power supply voltage on the basis of a device power supply voltage applied by a device power supply and the second voltage regulator is configured to generate a second power supply voltage on the basis of a device power supply voltage applied by the device power supply. The controller is configured to control the first LSI, to operate on the second power supply voltage, and to report an abnormality in the first LSI to a host system in accordance with the reception of an abnormality signal indicating an abnormality in the first LSI. The current monitoring and determination module is configured to monitor current flowing between the first LSI and the first voltage regulator, to determine an abnormality in the first LSI on the basis of the current monitoring result, and to transmit the abnormality signal to the controller on the basis of the abnormality determination result. The current monitoring and determination module is provided outside the first LSI and controller and is configured to operate on a device power supply voltage supplied from the device power supply.

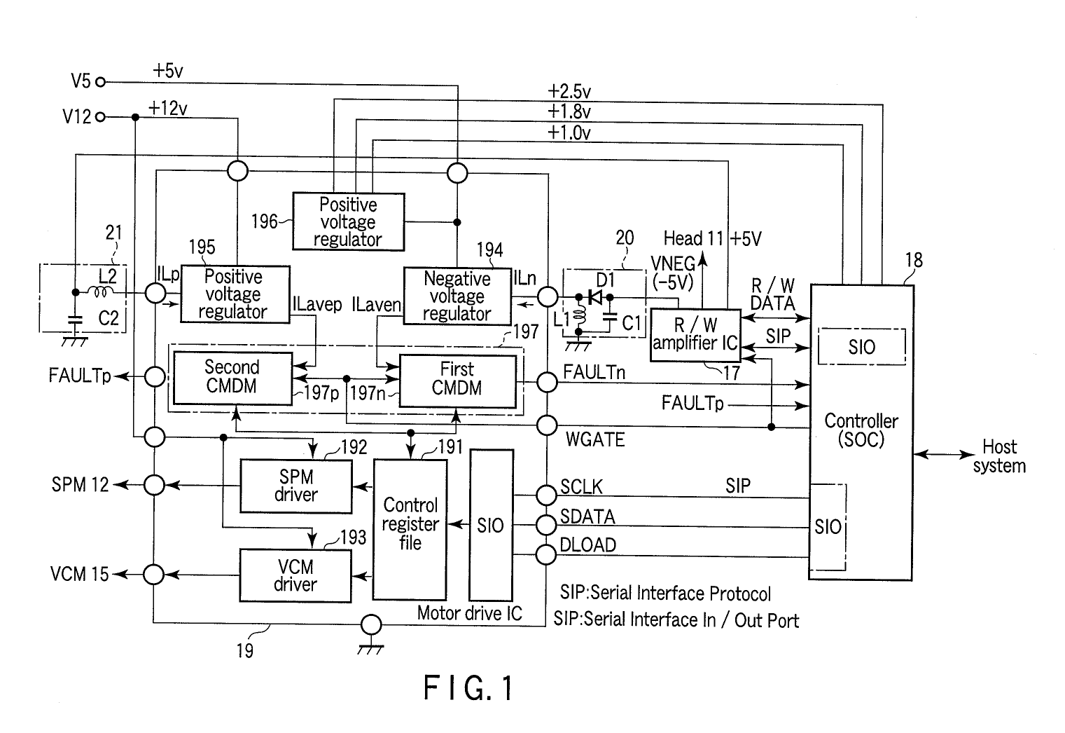

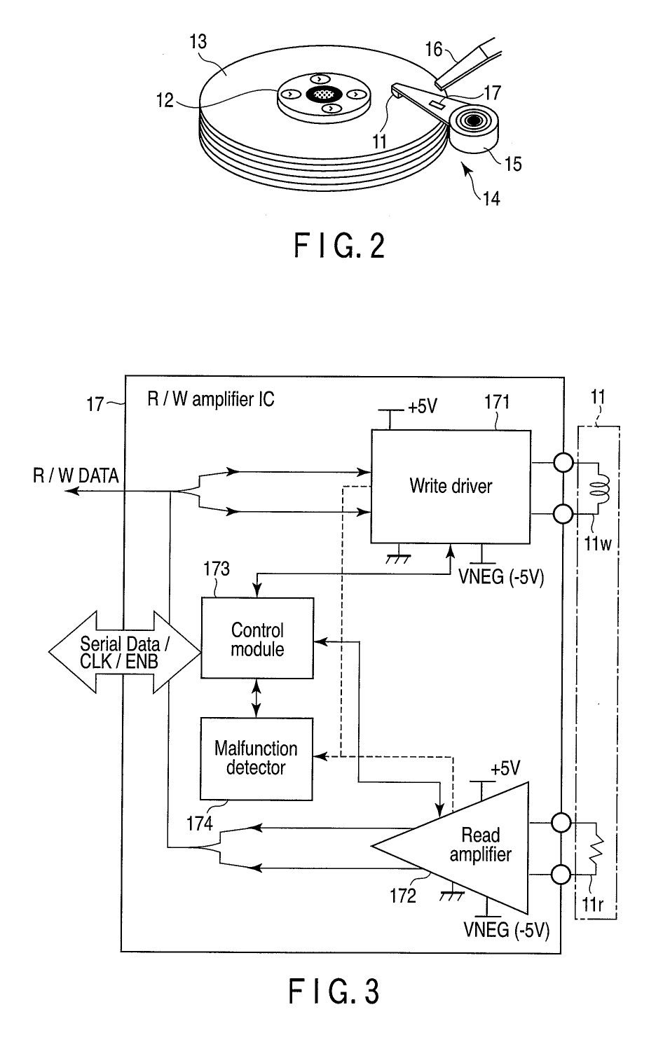

FIG. 1 is a block diagram showing the configuration of a magnetic disk drive (hereinafter, referred to as an HDD) according to an embodiment. FIG. 2 shows a configuration of the main mechanical part of the HDD. In the HDD, a spindle motor (SPM) 12 rotates a disk (magnetic disk) 13 at a high speed, causing a head (magnetic head) 11 to fly above the disk 13. In the embodiment, an HDD where a plurality of disks including the disk 13 are stacked one on top of another is used as shown in FIG. 2. In this case, a head is provided so as to correspond to either side of each disk. To simplify the explanation, suppose the HDD has a single head 11.

The head 11 is provided at the tip of an actuator 14. The actuator 14 has a voice coil motor (VCM) 15 acting as a driving source of the actuator 14. The actuator 14, which is driven by the VCM 15, moves the head 11 radially relative to the disk 13. The operation of the actuator 14 causes the head 11 to be positioned on the target track of the disk 13. A ramp 16 is provided in a position off the recording surface of the disk 13, for example, in a position near the outer periphery of the disk 13. The ramp 16 provides a parking part for retracting the head 11 if needed.

The head 11 is connected to a read/write amplifier IC (hereinafter, referred to as a R/W amplifier IC) 17. The R/W amplifier IC 17 is a single-chip LSI (first LSI). For example, the R/W amplifier IC 17 is mounted on the actuator 14 in the form of an IC chip. The R/W amplifier IC 17 is connected to a controller 18.

The controller 18 is realized by a system LSI called a system-on-chip (SOC) where, for example, a read/write channel, a disk controller, a flash ROM, a RAM, and a CPU are integrated into a single chip. The read/write channel, disk controller, flash ROM, RAM, and CPU are known components in the HDD. In the flash ROM, a control program (firmware) executed by the CPU is stored.

The controller 18 is connected to a host system. The host system uses the HDD as a storage device of the host system. The host system and HDD are included in an electronic device, such as a personal computer, a video camera, a music player, a personal digital assistant, or a mobile phone.

The controller 18 is connected to a motor drive IC 19 via a serial interface input/output port SIO. The motor drive IC 19 is connected to the SPM 12 and VCM 15. The motor drive IC 19 is a single chip LSI (second LSI) which includes a control register file 191, an SPM driver 192, a VCM driver 193, a negative voltage regulator (first voltage regulator) 194, a positive voltage regulator (third voltage regulator) 195, and a positive voltage regulator (second voltage regulator) 196.

The control register file 191 is used to hold control parameters and the like set by the controller 18 via the serial interface input/output port SIO. The SPM driver 192 and VCM driver 193 supply driving currents (SPM current and VCM current) specified by control parameters for driving the SPM 12 and VCM 15 set in the control register file 191 to the SPM 12 and VCM 15, respectively.

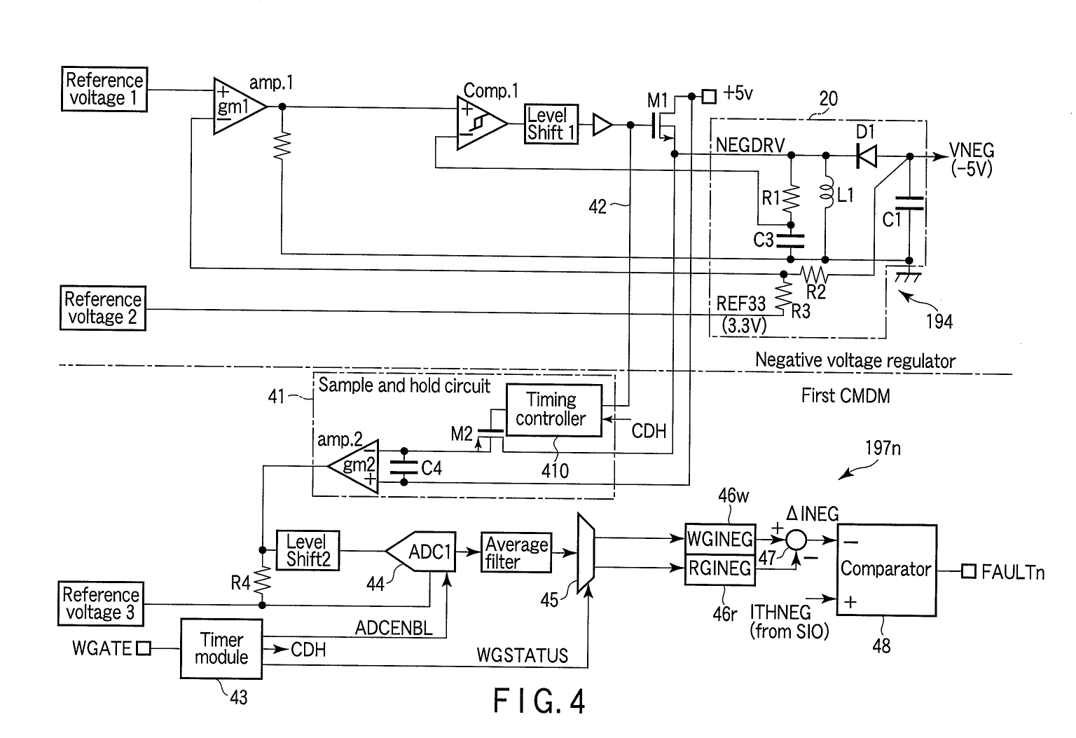

In the embodiment, a +12-V device power supply V12 and a +5-V device power supply V5 are used as device power supplies for the HDD. The negative voltage regulator 194 is, for example, a switching regulator which operates on a +5-V power supply voltage supplied from the device power supply V5. The negative voltage regulator 194 generates a positive voltage NEGDRV (FIG. 4) necessary to generate, for example, a −5-V negative voltage VNEG from the +5-V power supply voltage. The positive voltage NEGDRV is applied to an external smoothing and stabilization circuit 20 provided on the negative voltage regulator 194. A detailed configuration of the smoothing and stabilization circuit 20 is shown in FIG. 4.

The smoothing and stabilization circuit 20, which includes a polarity reversal circuit, converts the positive voltage NEGDRV into a stable −5-V negative voltage VNEG. The polarity reversal circuit is composed of a coil L1 and a diode D1. The −5-V negative voltage VNEG is applied to the R/W amplifier IC 17. Therefore, the smoothing and stabilization circuit 20 can be regarded as a part of the negative voltage regulator 194. Therefore, in the explanation below, suppose the negative voltage regulator 194 includes the smoothing and stabilization circuit 20. Also suppose the negative voltage regulator 194 generates, for example, a −5-V negative voltage VNEG from the +5-V power supply voltage. That is, the negative voltage regulator 194 provides a −5-V negative power supply VNEG for the R/W amplifier IC 17. The smoothing and stabilization circuit 20 may be incorporated in the negative voltage regulator 194.

The positive voltage regulator 195 is, for example, a switching regulator which operates on a +12-V power supply voltage supplied from the device power supply V12. The positive voltage regulator 195 steps down the +12-V power supply voltage to, for example, +5 V. The positive voltage regulator 195 applies a voltage of +5 V (positive voltage) to the R/W amplifier IC 17 via an external smoothing circuit 21 provided on the positive voltage regulator 195. Therefore, the smoothing circuit 21 can be regarded as a part of the positive voltage regulator 195. Therefore, in the explanation below, suppose the positive voltage regulator 195 includes the smoothing circuit 21. That is, the positive voltage regulator 195 provides a +5-V positive power supply for the R/W amplifier IC 17. The smoothing circuit 21 is composed of a coil L2 and a capacitor C2.

The +5-V positive power supply provided by the positive voltage regulator 195 may be used as a power supply for the negative voltage regulator 194 in place of the device power supply V5. The device power supply V5 may be used as a +5-V positive power supply for the R/W amplifier IC 17. The smoothing circuit 21 may be incorporated in the positive voltage regulator 195.

The positive voltage regulator 196 operates on the +5-V power supply voltage supplied from the device power supply V5. The positive voltage regulator 196 steps down the +12-V power supply voltage to a plurality of power supply voltages, for example, +2.5 V, +1.8 V, and +1.0 V, and applies the respective voltages to the controller 18. In this case, +2.5 V, +1.8 V, and +1.0 V are used as the power supply voltages for the read/write channel, RAM, and CPU in the controller 18.

The motor drive IC 19 further includes a current monitoring and determination module (hereinafter, referred to as a CMDM) 197. Suppose the CMDM 197 operates on the +12-V power supply voltage supplied from the device power supply V12. The CMDM 197 is composed of a first CMDM 197n provided so as to correspond to the negative voltage regulator 194 and a second CMDM 197p provided so as to correspond to the positive voltage regulator 195.

The first CMDM 197n monitors a current (average current) ILaven obtained by time-averaging current ILn flowing between the negative voltage regulator 194 and R/W amplifier IC (i.e., coil current ILn flowing in coil L1). The current ILn is proportional to a load current (negative power supply current) in the negative power supply (−5-V power supply VNEG) of the R/W amplifier IC 17.

The first CMDM 197n relatively compares average current ILaven (a first average current) when the R/W amplifier IC 17 in a state for a write operation (or the write state) with average current ILaven (a second average current) when the R/W amplifier IC 17 is in a state for a read operation (or the read state). On the basis of the comparison result, the first CMDM 197n determines whether the R/W amplifier IC 17 is abnormal. In this case, the first CMDM 197n compares a difference ΔINEG between the two average currents ILaven with the first threshold value ITHNEG set in the control register file 191. On the basis of the comparison result, the first CMDM 197n determines whether the difference ΔINEG is abnormal, thereby determining whether the R/W amplifier IC 17 (more precisely, write current supplied to the write element 11w of the head 11 by the R/W amplifier IC 17) is abnormal. If having determined that the R/W amplifier IC 17 is abnormal, the first CMDM 197n reports this. For example, the first CMDM 197n sends, for example, a high-level fault signal FAULTn to the controller 18.

The second CMDM 197p monitors current (average current) ILavep obtained by time-averaging current ILp flowing between the positive voltage regulator 195 and R/W amplifier IC (i.e., coil current ILp flowing in coil L2). Current ILp is proportional to a load current (positive power supply current) in the positive power supply (+5-V power supply) of the R/W amplifier IC 17.

The second CMDM 197p relatively compares average current ILavep (a third average current) when the R/W amplifier IC 17 in the write state with average current ILavep (a fourth average current) when the R/W amplifier IC 17 is in the read state. On the basis of the comparison result, the second CMDM 197p determines whether the R/W amplifier IC 17 is abnormal. In this case, the second CMDM 197p compares a difference ΔIPOS between the two average currents ILavep with the second threshold value ITHPOS set in the control register file 191. On the basis of the comparison result, the second CMDM 197p determines whether the difference ΔIPOS is abnormal, thereby determining whether the R/W amplifier IC 17 is abnormal. If having determined that the R/W amplifier IC 17 is abnormal, the second CMDM 197p reports this. For example, the second CMDM 197p sends, for example, a high-level fault signal FAULTp to the controller 18.

In the embodiment, the fault signal FAULTn from the first CMDM 197n is ORed with the fault signal FAULTp from the second CMDM 197p in, for example, the controller 18. The ORed signal is used as a fault signal FAULT. When having received the fault signal FAULT, that is, having received either the fault signal FAULTn or fault signal FAULTp, the controller 18 determines that the abnormality of the R/W amplifier IC 17 has been detected. In this case, the controller 18 stops the write operation and informs the host system of the abnormality of the R/W amplifier IC 17.

As is clear from the explanation, the controller 18, motor drive IC 19 (more precisely, CMDM 197 in the motor drive IC19), and R/W amplifier IC 17 in the HDD of FIG. 1 constitute a monitoring system in the HDD. In the monitoring system, the R/W amplifier IC 17 is a monitored device. The controller 18 and motor drive IC19 can be regarded as monitoring devices which share the monitoring of the R/W amplifier IC 17 (monitored device).

As described above, with the embodiment, the abnormality of the monitored device (R/W amplifier IC 17) is detected by the motor drive IC 19 (more precisely, CMDM 197 in the motor drive IC19) acting as a monitoring device provided outside the R/W amplifier IC 17 acting as a monitored device. The monitoring device (CMDM 197) is provided not only outside the monitored device (R/W amplifier IC 17) but also outside the controller 18 acting as another monitoring device that informs the host system of the abnormality of the monitored device (R/W amplifier IC 17). Separate power supplies apply power supply voltages to the monitored device and two monitoring devices. Accordingly, with the monitoring system applied to the embodiment, even if the monitored device (R/W amplifier IC 17) has failed, or even if a power supply voltage supplied to the monitored device has become abnormal, the abnormality can be detected correctly as the abnormality of the monitored device as a result of the load current detected by the CMDM 197 becoming abnormal. This makes it possible to increase the reliability of the detection of an abnormality in the monitored device.

In the embodiment, the CMDM 197 monitors average current ILaven corresponding to the negative voltage regulator 194 and average voltage ILavep corresponding to the positive voltage regulator 195. However, the CMDM 197 may be configured to monitor either average current ILaven or average voltage ILavep, for example, only average current ILaven. In this case, the second CMDM 197p is unnecessary.

FIG. 3 is a block diagram showing the configuration of the R/W amplifier IC 17. The R/W amplifier IC 17, which has a known configuration, comprises a write driver 171, a read amplifier 172, a control module 173, and a malfunction detector 174. Each of the write driver 171 and read amplifier 172 operates on the +5-V power supply voltage applied by the positive voltage regulator 195 and the −5-V power supply voltage VNEG applied by the negative voltage regulator 194.

The write driver 171 includes a write driver circuit that supplies write current corresponding to write data to a write element 11w of the head 11 and a write element bias circuit that supplies bias current to the write element 11w. The read amplifier 172 includes a read signal amplifier that amplifies a read signal reproduced by a read element 11r of the head 11 and a read element bias circuit that supplies bias current to the read element 11r.

When a command given by the controller 18 via the serial interface input/output port SIO specifies a write operation, the control module 173 of the R/W amplifier IC 17 causes the write driver 171 to supply write current corresponding to the write data sent from the controller 18 to the write element 11w of the head 11. The write current is supplied during the period of the write state indicated by a write gate signal WGATE sent from the controller 18. The write gate signal WGATE becomes high level so as to indicate the write state only in the period corresponding to a data sector on the disk 13 to be written into and becomes low level so as to indicate the non-write state in the other period. The other period includes periods (hereinafter, referred to as write pause periods) corresponding to a boundary part between data sectors to be written into (gap parts) and a servo area (a servo area where writing is inhibited) from which servo data is to be read.

Similarly, when a command given by the controller 18 specifies a read operation, the control module 173 causes a read element (e.g., magnetoresistive [MR] element) 11r of the head 11 to convert data (magnetic pattern) magnetically recorded on the disk 13 into an electrical signal. The data is converted into an electrical signal during the period of the read state indicated by write gate signal WGATE sent from the controller 18. The control module 173 causes the read amplifier 172 to amplify the converted electrical signal (read signal) and sends the amplified signal to the controller 18.

The malfunction detector 174 of the R/W amplifier IC 17 has the function of monitoring the R/W amplifier IC 17 (more precisely, the power supply voltages of the write driver 171, read amplifier 172, and others in the R/W amplifier IC 17). The malfunction detector 174 also has the function of detecting the following abnormality: the write element of the head 11 is in the shorted state or opened state. The malfunction detector 174 further has the function of detecting an abnormality in the frequency of write data and an abnormality in the environmental temperature of the R/W amplifier IC 17.

The R/W amplifier IC 17 further includes a heater driver (not shown). The heater driver supplies electrical energy to a heater element (e.g., resistive heating element). The heater element is incorporated into the head. Thermally expanding a specific part of the head causes the read element and write element in the head 11 to stick out, thereby adjusting the distance (i.e., the spacing) between the read element and write element and the disk 13.

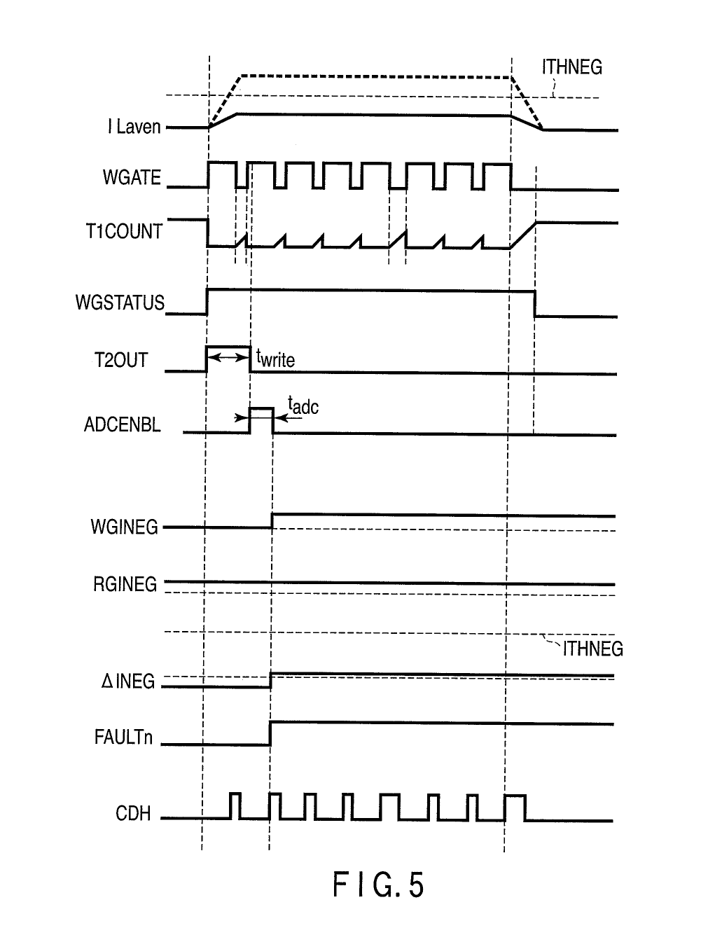

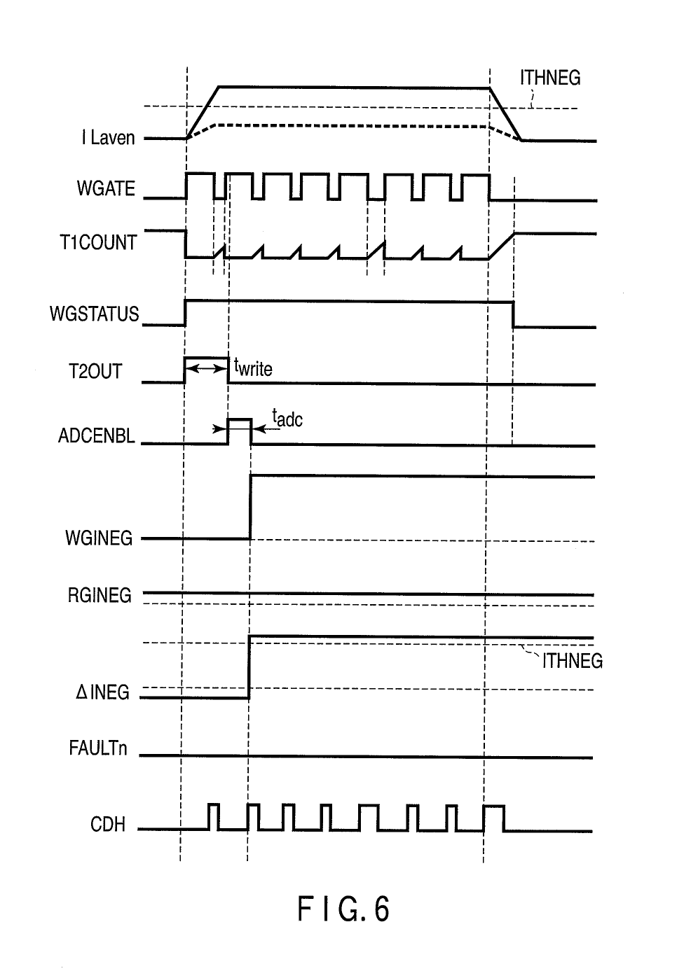

Next, the configuration of the negative voltage regulator 194 and the first CMDM 197n and an operation centering on the first CMDM 197n will be explain with reference to FIGS. 4 to 6. FIG. 4 shows the configuration of the negative voltage regulator 194 and the first CMDM 197n in the motor drive IC 19. FIG. 5 is a timing chart when the first CMDM 197n detects that the R/W amplifier IC 17 is abnormal. FIG. 6 is a timing chart when the first CMDM 197n detects that the R/W amplifier IC 17 is normal.

As shown in FIG. 4, the negative voltage regulator 194 includes a power metal-oxide semiconductor field-effect transistor (MOSFET) M1 for applying a −5-V negative voltage VNEG via the smoothing and stabilization circuit 20. The first CMDM 197n includes a sample-and-hold circuit 41.

The sample-and-hold circuit 41 (first average current detector) is used to detect average current ILaven in a period t_{write} of current ILn flowing in the coil L1 of the smoothing and stabilization circuit 20. Current ILn flows in the coil L1 in accordance with voltage Vds between the drain and source of power MOSFET M1 during the period when power MOSFET M1 of the negative voltage regulator 194 is made on by the signal 42.

The sample-and-hold circuit 41 includes a MOSFET M2 used as a switch, a timing controller 410 that controls MOSFET M2, and a capacitor C4. On the basis of the signal 42 and signal CDH, the timing controller 410 makes MOSFET M2 on only in the period when the signal 42 is high level and signal CDH is low level. Signal CDH is low level in the period when write gate signal WGATE is high level to indicate the write state and is high level in the period when write gate signal WGATE is low level to indicate a write pause period (read state). That is, MOSFET M2 is on only in the period of the write state when power MOSFET M1 is on.

The drain of MOSFET M2 is connected to the source of power MOSFET M1. Capacitor C4 is connected between the source of MOSFET M2 and the drain of power MOSFET M1. As a result, current ILn causes charges to be stored in capacitor C4 during the period when MOSFET M2 is on.

As described above, in the embodiment, during the period when MOSFET M2 is on, current ILn is accumulated and the accumulated value is held as average current ILaven (FIGS. 5 and 6) in the sample-and-hold circuit 41. That is, when power MOSFET M1 is on, current ILn is accumulated in the period when write gate signal WGATE indicates the write state. This means that the accumulation of current ILn is suppressed in the period when signal CDH is high level, even if the period is a short write pause period between write states developing intermittently. Consequently, a fluctuation in current ILn caused by a temporary transition from the write state to the read state in the write pause period is masked at the sample-and-hold circuit 41.

The first CMDM 197n further includes a timer module 43, an analog-to-digital converter (ADC) 44, a demultiplexer 45, registers 46w and 46r, a subtractor 47, and a comparator 48.

In accordance with write gate signal WGASTE, the timer module 43 outputs the following three control signals: ADCENBL, CDH, and WGSTATUS (FIGS. 5 and 6). The timer module 43 has a first and a second timer.

The first timer counts the low-level period (write pause period) each time write gate signal WGATE transits to low level. Count T1COUNT of the first timer is reset to zero in accordance with the transition of write gate signal WGATE from low level to high level. In the embodiment, count T1COUNT of the first timer has the upper limit. Even if the low-level period has exceeded a period predetermined by, for example, the controller 18, count T1COUNT does not increase beyond the upper limit.

The timer module 43 outputs a high-level signal WGSTATUS indicating the write mode during the period when count T1COUNT of the first timer is less than the upper limit. The write mode indicates a state where the write state occurs intermittently so as to sandwich a short write pause period therebetween. That is, in the period of the write mode, a series of write operations are carried out intermittently. The short write pause period, which is a period shorter than a preset period, indicates a period when count T1COUNT of the first timer is larger than 0 and smaller than the upper limit. More specifically, the short write pause period is a period when the head 11 passes over the gap part between adjacent data sectors or the servo area in the period when write gate signal WGATE becomes low level. That is, to detect and mask the short write pause period during the write state, the first timer is used to count the period (write pause period) when write gate signal WGATE is low level.

The second timer counts the period t_{write} set in the control register file 191 from when signal WGSTATUS transits from low level to high level (i.e., from when the write mode starts) and outputs a high-level signal T2OUT (FIGS. 5 and 6) only during the period t_{write}. The period t_{write} (more precisely, a parameter indicating period t_{write}) is set by the controller 18, for example, immediately after the startup of the HDD and before the first write operation.

The timer module 43 outputs a high-level signal SDCENBL during only the period t_{adc} set in the control register file 191 from when signal T2OUT transits to low level. The period t_{adc} (more precisely, a parameter indicating the period t_{adc}) is set by the controller 18, for example, immediately after the startup of the HDD and before the first write operation. The timer module 43 sets signal ADCENBL to high level during only the period t_{adc} from when, for example, the read state (read mode) predetermined by the controller 18 is started.

That is, signal ADCENBL is set high level during the period t_{adc} from when the period t_{write} has elapsed from the start of the write mode and during the period t_{adc} from the start of the predetermined read mode. The period t_{adc} is the time required for the ADC 44 to convert average current ILaven held in the sample-and-hold circuit 41 into a digital value.

The predetermined read mode is the read mode for reading a management table (an alternative sector management table or an alternative track management table) saved in a specific area called a system area on the disk 13, for example, after the power supply of the HDD is turned on. As is generally known, the management table shows the correspondence relationship between defective sectors (or defective tracks) and alternative sectors (or alternative tracks) used in place of the defective sectors (or defective tracks). The read management table is stored in the RAM in the controller 18 and used to access the management table at high speed. The predetermined read mode may be other than the read mode for reading the management table. Alternatively, the predetermined read mode may be the read mode preceding the write mode.

The timer module 43 further outputs signal CDH which becomes high level during only the period when write gate signal WGATE is low level. Signal CDH is input to a timing controller 410. The ADC 44 reads average current ILaven held in the sample-and-hold circuit 41 in accordance with the transition of signal ADCENBL to high level. It is when the period t_{write} has elapsed since the start of the write mode that signal ADCENBL transits to high level in the period when signal WGSTATUS is high level (i.e., in the write mode).

As described above, in the embodiment, the time when the ADC 44 reads average current ILaven held in the sample-and-hold circuit 41 in the write mode is delayed for the period t_{write} from the start of the write mode. The reason is that a delayed response of the negative power supply causes a delay (FIGS. 5 and 6) in the increase or decrease (in this case, increase) of average current ILaven of current ILn immediately after the start of the write mode (i.e., immediately after the switch-over to the write mode). Therefore, to reduce an error caused by a delay in the response of the negative power supply in detecting average current ILaven converted by the ADC 44 into a digital value, the timer module 43 causes the second timer to delay the start of the operation of the ADC 44 for the period t_{write} from the start of the write mode.

The ADC 44 converts the read average current (first average current) ILaven into a digital value and outputs the digital value. The demultiplexer 45 selectively outputs the digital value output from the ADC 44 to the register 46w or 46r according to signal WGSTATUS. In the embodiment, the digital value converted and output by the ADC 44 in the period when signal WGSTATUS is high level (i.e., in the write mode) is output as digital value (first digital value) WGINEG (FIGS. 5 and 6) to the register 46w and held in the register 46w. On the other hand, the digital value output by the ADC 44 in the period when signal WGSTATUS is low level (in this case, in the period of the read mode) is output as digital value (second digital value) RGINEG (FIGS. 5 and 6) to the register 46r and held in the register 46r.

The subtractor 47 calculates a difference ΔINEG (FIGS. 5 and 6) between digital value WGINEG held in the register 46w and digital value RGINEG held in the register 46r. The comparator 48 compares the difference ΔINEG with threshold value (first threshold value) ITHNEG preset in the control register file 191 (e.g., set immediately after the startup of the HDD and before the first write operation) by, for example, the controller 18.

If the difference ΔINEG is less than threshold value ITHNEG (FIG. 5), the comparator 48 determines that the R/W amplifier IC 17 is abnormal. In this case, the comparator 48 sends to the controller 18 a high-level fault signal FAULTn (FIG. 5) indicating that the R/W amplifier IC 17 is abnormal. In contrast, if the difference ΔINEG is not less than threshold value ITHNEG (FIG. 6), the comparator 48 determines that the R/W amplifier IC 17 is normal. In this case, the comparator 48 keeps fault signal FAULTn at low level to indicate that the R/W amplifier IC 17 is normal (FIG. 6).

Here, an explanation will be given as to why the difference in current ILn (more precisely, digital value WGINEG of average current ILaven) in each of the write state and read state is compared with threshold value ITHNEG. In the write state, electrical energy is mostly consumed by the write driver circuit and write element bias circuit in the write driver 171 and the read signal amplifier circuit and read element bias circuit in the read amplifier 172. That is, in the write state, consumption current flows in the write driver circuit, write element bias circuit, read signal amplifier circuit, and read element bias circuit. The consumption current flowing in the write driver circuit corresponds to write current flowing in the write element 11w of the head 11. In the read state, electrical energy is mainly consumed by the read signal amplifier circuit and read element bias circuit in the read amplifier 172. That is, in the read state, consumption current flows in the read signal amplifier circuit and read element bias circuit.

It is known that the write driver circuit and read signal amplifier circuit are significantly affected by characteristic variations in the write element 11w and read element 11r. In contrast, it is known that the write element bias circuit and read element bias circuit are not noticeably affected by characteristic variations in the write element 11w and read element 11r and that, even if they are influenced, the degree of the influence is low. Accordingly, current flowing in the write element bias circuit and read element bias circuit does not significantly affect currents ILn and ILp detected by the CMDM 197.

Next, in the read state, the power supply of the write driver circuit and write element bias circuit (i.e., the power supply of the write driver 171) is turned off. In contrast, in the write state, the power supply of the read signal amplifier circuit and read element bias circuit (i.e., the power supply of the read amplifier 172) is kept on to minimize transient fluctuations in the output signal after a write operation.

Here, suppose the CMDM 197 determines whether the R/W amplifier IC 17 is abnormal, particularly, whether write current flowing the write element 11w of the head 11 is abnormal, on the basis of only current detected in, for example, the write state without using the difference differently from the embodiment. Since the CMDM 197 is provided outside the R/W amplifier IC 17, it cannot directly detect write current differently from the malfunction detector 174 included in the R/W amplifier IC 17. Therefore, the CMDM 197 detects a load current in the negative power supply for the R/W amplifier IC 17, that is, a negative power supply current (more precisely, a coil current proportional to the negative power supply current) instead of detecting write current.

However, the load current in the write state includes not only write current (consumption current flowing in the write driver) but also consumption current flowing in the read signal amplifier circuit and read element bias circuit. In addition, the consumption current flowing in the read signal amplifier circuit and read element bias circuit might reach or exceed the write current. In such a case, the load current detected in the write state does not necessarily reflect the state of the write current. Accordingly, even if an abnormality in the write current is determined on the basis of only the load current detected in the write state, an accurate determination result cannot be expected.

In contrast, if the difference between the load current in the write state and that in the read state is calculated as in the embodiment, that is, if the load current in the write state is relatively compared with the load current in the read state, consumption current flowing in the read signal amplifier circuit and read element bias circuit can be almost cancelled. Therefore, the difference reflects the state of the write current sufficiently. Accordingly, as in the embodiment, if an abnormality in the write current is determined on the basis of the difference, an accurate determination result can be obtained.

The second CMDM 197p has the same configuration as that of the first CMDM 197n. Therefore, an explanation of the configuration and operation of the second CMDM 197p will be omitted. In the explanation of the first CMDM 197n, read the first CMDM 197n as the second CMDM 197p, the negative voltage regulator 194 as the positive voltage regulator 195, the negative power supply as the positive power supply, the negative voltage as the positive voltage, current ILn as current ILp, average current ILaven as average current ILavep, the sample-and-hold circuit 41 (first average current detector) as the second average current detector, the ADC 44 (first analog-to-digital converter) as the second analog-to-digital converter, the comparator 48 (first comparator) as the second comparator, digital value WGINEG as digital value WGIPOS, digital value RGINEG as digital value RGIPOS, difference ΔINEG as difference ΔIPOS, the first threshold value ITHNEG as the second threshold value ITHPOS, and fault signal FAULTn as fault signal FAULTp, if necessary.

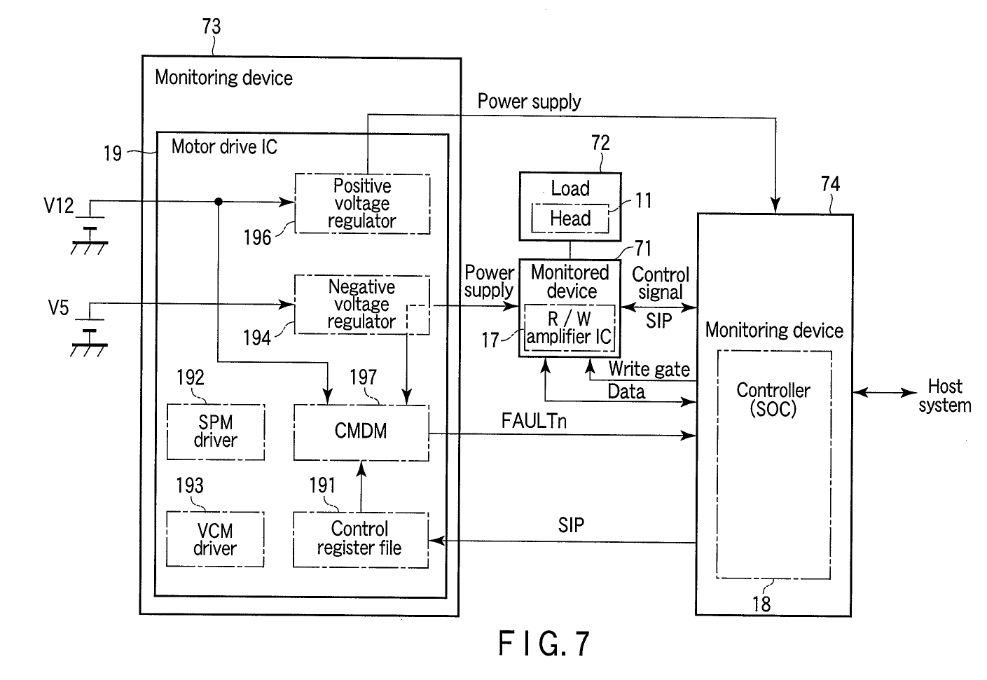

FIG. 7 is a block diagram showing a configuration of the monitoring system in the HDD in connection with the components of the HDD. In FIG. 7, a monitored device 71 is a first LSI composed of the R/W amplifier IC 17 of the HDD. A load 72 on the monitored device 71 is composed of the head 11 of the HDD. A monitoring device 73 is composed of a motor drive IC 19 acting as a second LSI including, for example, the negative voltage regulator 194 and CMDM 197 in the HDD. A monitoring device 74 is composed of a controller (SOC) 18 in the HDD. The CMDM 197 may be provided outside the motor drive IC 19 and the monitoring device 73 may be composed of the CMDM 197.

The embodiment is based on the assumption that the monitoring system is configured in the HDD. As is clear from the configuration of FIG. 7, the monitoring system can be applied to any suitable device other than the HDD.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a first Large-Scale Integration (LSI) unit configured to drive a load by supplying current to the load and to operate on a first power supply voltage;
a second LSI unit comprising a first voltage regulator and a second voltage regulator, the first voltage regulator being configured to generate the first power supply voltage on the basis of a device power supply voltage applied by a device power supply, and the second voltage regulator being configured to generate a second power supply voltage on the basis of the device power supply voltage applied by the device power supply;
a controller configured to control the first LSI unit, to operate on the second power supply voltage, and to report an abnormality in the first LSI unit to a host system in accordance with the reception of an abnormality signal indicating an abnormality in the first LSI unit; and
a current monitoring and determination module configured to monitor current flowing between the first LSI unit and the first voltage regulator, to determine an abnormality in the first LSI unit on the basis of the current monitoring result, and to transmit the abnormality signal to the controller on the basis of the abnormality determination result, the current monitoring and determination module being provided outside the first LSI unit and controller and being configured to operate on the device power supply voltage supplied from the device power supply.

2. The system of claim 1, wherein:
the load is a head in a magnetic disk drive;
the first LSI unit is a read and write amplifier Integrated Circuit (IC) in the magnetic disk drive, the read and write amplifier being configured to supply current to the head in a write state;
the second LSI unit is a motor drive IC in the magnetic disk drive, the motor drive IC being configured to drive a spindle motor and a voice coil motor; and
the current monitoring and determination module is provided in a chassis of the magnetic disk drive.

3. The system of claim 2, wherein the controller is configured to stop a write operation in accordance with the reception of the abnormality signal in the write state.

4. The system of claim 2, wherein the current monitoring and determination module is configured to determine an abnormality in the read and write amplifier IC by a relative comparison between a first current monitoring result in the write state and a second current monitoring result in a read state.

5. The system of claim 4, wherein the current monitoring and determination module comprises an average current detector configured to detect as the first current monitoring result a first average current having an average value of current flowing between the read and write amplifier IC and the first voltage regulator in the write state and to detect as the second current monitoring result a second average current having an average value of current flowing between the read and write amplifier IC and the first voltage regulator in the read state.

6. The system of claim 5, wherein the current monitoring and determination module further comprises a comparator configured to compare a value equivalent to the difference between the first average current and the second average current with a threshold value set by the controller and to determine an abnormality in the read and write amplifier IC on the basis of the comparison result.

7. The system of claim 6, wherein:
the current monitoring and determination module comprises an analog-to-digital converter configured to convert the first average current after a time set by the controller has elapsed since the start of a write mode into a first digital value and to convert the second average current in the read state into a second digital value; and
the comparator is configured to use the difference between the first digital value and the second digital value as a value equivalent to the difference between the first average current and the second average current.

8. The system of claim 6, wherein the current monitoring and determination module further comprises a first register configured to hold the first digital value and a second register configured to hold the second digital value.

9. The system of claim 2, wherein the motor drive IC comprises the current monitoring and determination module.

10. The system of claim 2, wherein:
the read and write amplifier IC is configured to operate on the first power supply voltage and a third power supply voltage;
the first power supply voltage is a negative voltage and the third power supply voltage is a positive voltage;
the motor drive IC comprises a third voltage regulator configured to generate the third power supply voltage on the basis of the device power supply voltage supplied from the device power supply; and
the current monitoring and determination module comprises:
a first current monitoring and determination module configured to monitor a current flowing between the read and write amplifier IC and the first voltage regulator as a first current and to determine an abnormality in the read and write amplifier IC on the basis of the result of monitoring the first current in the write state; and
a second current monitoring and determination module configured to monitor a current flowing between the read and write amplifier IC and the third voltage regulator as a second current and to determine an abnormality in the read and write amplifier IC on the basis of the result of monitoring the second current in the write state.

11. The system of claim 10, wherein:
the first current monitoring and determination module is configured to determine an abnormality in the read and write amplifier IC by an relative comparison between a first current monitoring result, the result of monitoring the first current in the write state, and a second current monitoring result, the result of monitoring the first current in a read state; and
the second current monitoring and determination module is configured to determine an abnormality in the read and write amplifier IC by an relative comparison between a third current monitoring result, the result of monitoring the second current in the write state, and a fourth current monitoring result, the result of monitoring the second current in the read state.

12. The system of claim 11, wherein:
the first current monitoring and determination module comprises a first average current detector configured to detect as the first current monitoring result a first average current having an average value of the first current flowing between the read and write amplifier IC and the first voltage regulator in the write state and to detect as the second current monitoring result a second average current having an average value of the first current flowing between the read and write amplifier IC and the first voltage regulator in the read state; and
the second current monitoring and determination module comprises a second average current detector configured to detect as the third current monitoring result a third average current having an average value of the second current flowing between the read and write amplifier IC and the third voltage regulator in the write state and to detect as the fourth current monitoring result a fourth average current having an average value of the second current flowing between the read and write amplifier IC and the third voltage regulator in the read state.

13. The system of claim 12, wherein:
the first current monitoring and determination module further comprises a first comparator configured to compare a first value equivalent to the difference between the first average current and the second average current with a first threshold value set by the controller and to determine an abnormality in the read and write amplifier IC on the basis of the result of the comparison between the first value and the first threshold value; and
the second current monitoring and determination module further comprises a second comparator configured to compare a second value equivalent to the difference between the third average current and the fourth average current with a second threshold value set by the controller and to determine an abnormality in the read and write amplifier IC on the basis of the result of the comparison between the second value and the second threshold value.

14. The system of claim 13, wherein:
the first current monitoring and determination module further comprises a first analog-to-digital converter configured to convert the first average current after a time set by the controller has elapsed since the start of a write mode into a first digital value and to convert the second average current in the read state into a second digital value;
the second current monitoring and determination module further comprises a second analog-to-digital converter configured to convert the third average current after a time set by the controller has elapsed since the start of a write mode into a third digital value and to convert the fourth average current in the read state into a fourth digital value;
the first comparator is configured to use the difference between the first digital value and the second digital value as the first value; and
the second comparator is configured to use the difference between the third digital value and the fourth digital value as the second value.

15. The system of claim 14, wherein:
the first current monitoring and determination module further comprises a first register configured to hold the first digital value and a second register configured to hold the second digital value; and
the second current monitoring and determination module further comprises a third register configured to hold the third digital value and a fourth register configured to hold the fourth digital value.
